(19) United States
(12) Patent Application Publication
(10) Pub. No.: US 2012/0304256 A1
(43) Pub. Date: Nov. 29, 2012

(54) ELECTRONIC MAIL SYSTEM AND METHOD

(76) Inventor: Sion Euros Evans, Denbigh (GB)

(21) Appl. No.: 13/502,761

(22) PCT Filed: Oct. 21, 2010
(86) PCT No.: PCT/GB10/51773

§ 371 Date: Apr. 19, 2012

(30) Foreign Application Priority Data
Oct. 21, 2009 (GB) 0918419.3

(51) Int. Cl. G06F 21/00; G06F 15/16

(52) U.S. Cl. 726/4

(57) ABSTRACT

A method of handling e-mail messages and a server for performing the method are disclosed. In the method comprises, receiving an e-mail message from a sender for delivery to a recipient, and delivering the message if the sender is included in a list of senders authorised for communication with the recipient. Otherwise, the method parses a destination e-mail address in the message to extract from it an authorisation code and if the authorisation code is an acceptable code, adding the sender to the list of senders authorised for communication with the recipient and delivering the message. In the method, any authorisation code has a validity that us limited for a specific length of time.

### CROSS REFERENCE TO RELATED APPLICATION

This application is a national stage entry of PCT/GB2010/051773 filed Oct. 21, 2010, under the International Convention claiming priority over GB Application No. 0918419.3 filed Oct. 21, 2009.

### FIELD OF THE INVENTION

This invention relates to an electronic mail system and method. In particular, it relates to an electronic mail system and method that allows a user to control the mail that they will receive and reduce the number of unsolicited mail messages received.

### BACKGROUND TO THE INVENTION

Most users of Internet e-mail receive unsolicited e-mail messages (so-called, “spam”). These can be a problem due to their bulk alone and the time taken to deal with them, and potentially worse, they may expose people (children, in particular) to content that is wholly unsuitable.

Numerous schemes for reducing the number of unsolicited e-mail messages presented to a user have been proposed. These include systems of filtering based on the content of a message, “Baysian” systems that try to determine whether or not a message is wanted based on a large range of parameters, whitelisting and blacklisting of e-mail addresses or IP addresses, and challenge/response systems, amongst many others.

All of these systems have some problems. Systems that filter and analyse messages as subject to generating “false positives”, where messages that are not, in fact, unsolicited are marked as such, an so go unseen by their intended recipient. Systems that rely upon manual whitelisting and blacklisting of arbitrary addresses require a lot of maintenance if their lists are to remain up-to-date and challenge/response systems have the potential to create endless loops of messages if two such systems attempt to communicate with one another.

### SUMMARY OF THE INVENTION

An aim of this invention is to provide an electronic mail system and method that protects its users from unsolicited mail while overcoming, or at least ameliorating, the problems of known systems.

To this end, from a first aspect, the invention provides a method of handling e-mail messages comprising:

a. receiving an e-mail message from a sender for delivery to a recipient, delivering the message if the sender is included in a list of senders authorised for communication with the recipient; or

b. parsing a destination e-mail address in the message to extract from it an authorisation code and if the authorisation code is an acceptable authorisation code, adding the sender to the list of senders authorised for communication with the recipient and delivering the message;

c. wherein any authorisation code has a validity that is limited for a specific length of time.

From the point of view of the sender, no special software is required, since the authorisation code is included in the e-mail address. Therefore, addresses can be distributed in a conventional manner. However, the addresses cannot be used indefinitely as targets for unwanted, spam messages, because the authorisation code will become invalid after a period of time.

The authorisation code is typically an alphanumeric code. Most preferably, the alphanumeric code does not include characters that would be rejected as unacceptable for use in an e-mail address by typical e-mail software.

The authorisation code is an acceptable code if it is contained within a table of acceptable codes. Such a table will typically be maintained by an e-mail server that implements this invention. Alternatively or additionally, an algorithm can be applied to the authorisation code to determine whether it is an acceptable code. This avoids the need to provide a table, and allows authorisation codes to be generated without the need to involve the e-mail server. In such cases, one or both of the time of creation of the authorisation code and the time of expiry of validity of the authorisation code is encoded within the authorisation code. For example, the code may include an encrypted representation of a numerical time value such as the POSIX time. The representation may be an alphanumeric representation, and may be of fixed length. In addition, the code may include a checksum, hash or similar calculated portion that can be used to verify that the address as a whole has been constructed in accordance with predetermined rules.

The validity of the authorisation code may be limited to a period of several minutes, several hours or several days, as considered appropriate for a particular application.

From a second aspect, this invention provides a mail server operative to receive an e-mail message and handle it in accordance with a method embodying the first aspect of the invention.

From a third aspect, this invention provides a computer software product that can be executed on a computing platform to provide a mail server according to the second aspect of the invention.

From a fourth aspect, this invention provides a method of establishing e-mail communication comprising: a. connecting a mail server according to the second aspect of the invention to a network to receive e-mail messages from a sender; b. operating a web server connected to the network to serve code for a web page that includes an e-mail address that comprises an authorisation code, wherein subsequent instances of the code for the web page that are served have different authorisation codes.

This method can provide e-mail addresses of short-term availability to all, which can be used to allow a sender to obtain a long-term right to have their e-mail messages delivered to a recipient.

Typically, the page code for the web page served includes an HTML mail to link that contains the e-mail address including the authorisation code.

Methods embodying this aspect of the invention have particular, but not exclusive, application to establishment of e-mail communication over the Internet.

### BRIEF DESCRIPTION OF THE DRAWINGS

In the drawings:

FIG. 1 is a highly schematic diagram of a system of sending an e-mail message through a server in accordance with an embodiment of the invention; and

FIG. 2 shows a web page that a prospective contact can user to obtain an authorisation code to establish e-mail communication with a user of an embodiment of the invention;

FIG. 3 shows an alternative web page that a prospective contact can user to obtain an authorisation code to establish e-mail communication with a user of an embodiment of the invention; and

FIGS. 4 and 5 are flow charts that describe a method embodying the invention.

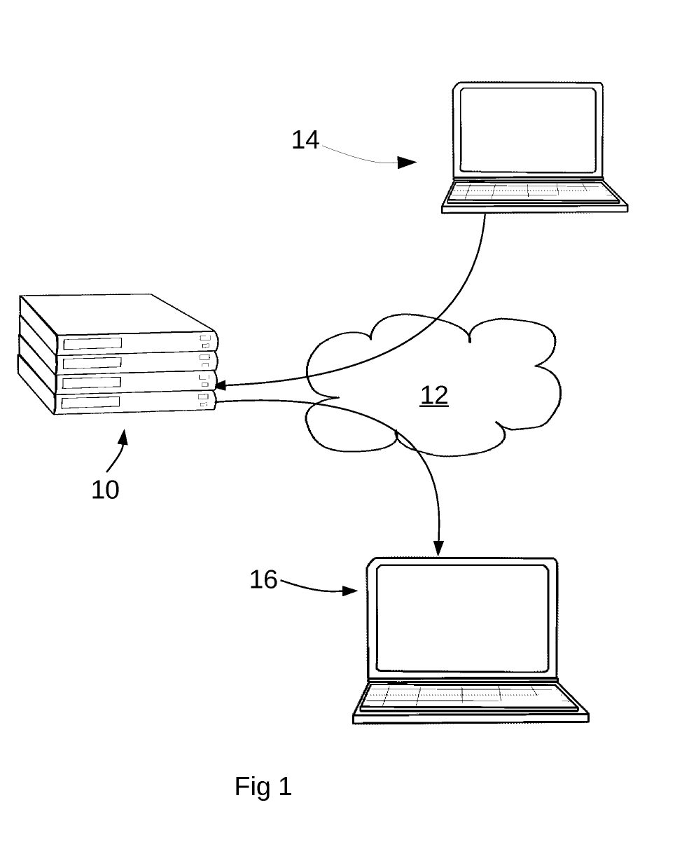

### DETAILED DESCRIPTION OF THE PREFERRED EMBODIMENT

An embodiment of the invention will now be described in detail, by way of example, with reference to the accompanying drawings.

This embodiment of the invention is implemented as a server software operating on a server computer 10 (the “system server”) that is connected to the Internet 12. Since the server 10 functions in much the same way as a conventional SMTP server, it can generally serve as a direct replacement for an existing mail server. To receive messages using the server, a user is first enrolled with a new user account.

To a subscribed e-mail user, the system provides the same function as a conventional incoming mail server, whereby a user can access their received e-mail messages using a network mail client program that operates using POP3, POP3S (POP3 over SSL) or IMAP, or have their messages delivered to a local mail server using SMTP. The system may also implement a web interface through which a user can access his or her messages. This functionality may be provided by known mail transfer agent such as Dovecot, Courier POP/I MAP, etc.

To the rest of the Internet, the system appears to function as a conventional SMTP server, and is operative to receive e-mail messages from other hosts using SMTP. However, the way in which these incoming messages are handled is not conventional and is specific to this invention.

Thus, when a remote computer user wishes to send an e-mail message to a user of the embodiment of the invention, the remote user uses a mail user agent on their computer 14 to create a message and send it over the Internet 12 (typically through a relay server) to the system server 10, which is listening for such messages on port 25.

Upon receipt of a message, the e-mail address specified in the message is analysed. If it is in the conventional form:

<user>@<domain>, e.g., bob@permissiontosend.com

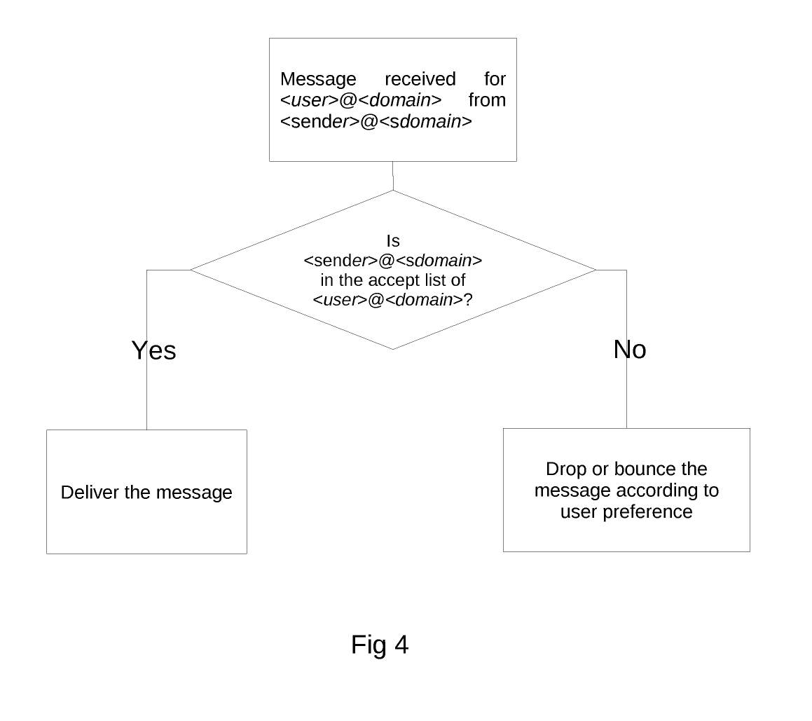

then it is processed as will now be described and is illustrated in FIG. 4. The assumption that is made by the server software is that the message will not be delivered to the addressee. The server then checks to determine whether the message meets criteria that will override this assumption and thereby allow the message to be delivered to the addressee. The most basic criterion for allowing delivery is that the sender is included in an accept list of the recipient. If the checks establish that the message should be delivered, it is placed in the user's mail store, from which it can be later accessed by the subscribed user through a mail user agent running on his or her computer 16. If the checks fail to establish that the message should be delivered, an error is returned to the sender (“bounced”), or the message is silently discarded, in accordance with the preferences of the operator of the system.

The e-mail address within the received message may alternatively include additional information (an alphanumeric authorisation code, in this embodiment) that can be used to add a sender to the accept list of the recipient. The authorisation code is incorporated into the e-mail address in a manner that will not cause a typical e-mail client to reject the address as being invalid. Several examples amongst many possibilities include:

<user><code>@<domain> e.g. bob123456@permissiontosend.com

<user>-<code>@<domain> e.g. bob-123456©permissiontosend.com

<user>.<code>@<domain> e.g. bob.123456©permissiontosend.com

<user>--<code>@<domain> e.g. bob--123456@permissiontosend.com

<user>+<code>@<domain> e.g. bob+123456@permissiontosend.com

<user>[<code>]@<domain> e.g. bob[123456]@permissiontosend.com

Examples 1, 2 and 3 are clear, but have the disadvantage that they can be confused with complete, valid e-mail addresses.

Examples 4 and 5 are also clear, and will be passed by any e-mail client that is aware of IETF RFC 5233 (“Sieve”), but have the disadvantage that the server may then not be able to implement RFC 5233 completely.

Example 6 is clear and unambiguous, but may fail validity checks performed by the e-mail client to validate the address prior to sending.

A valid authorisation code can be conveyed to a prospective sender in a variety of ways.

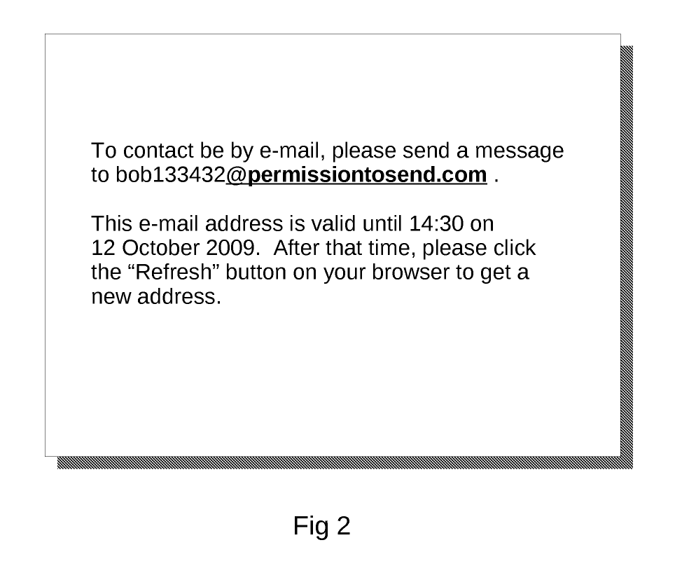

First, there are cases where a recipient wants to make their e-mail address public, for example using a web site, while protecting against receipt of mail from automated systems. In such cases, the e-mail address is displayed in the web page with an optional “mailto:” link with an authorisation code incorporated into it. This is shown diagrammatically in FIG. 2. Each time the page is served, a new authorisation code is obtained from the mail server by the web server hosting the page and displayed as part of the web page. That authorisation code then is valid for only a limited period of time, chosen by the operator of the server, after it has first been displayed. (A period of a few minutes may be appropriate in some cases, while longer periods may be more appropriate in others. This is for the operator of the server to decide.) If the complete e-mail address with the authorisation code is used by a sender within that time period, the sender is optionally added to the receivers accept list, and the authorisation code then becomes invalid for any other sender. If the sender is added to the accept list, the authorisation code can be omitted from the e-mail address used by the sender to send future messages to the recipient.

Note that several authorisation codes may be valid at any one time, since the web page may be accessed by several users in quick succession, and each of them should be able to use the authorisation code that is displayed on their instance of the web page.

In this example, the authorisation code is generated algorithmically using a pseudo-random number generator, which can be used to generate a numerical code directly or can be encoded into an alphanumeric string. Such algorithms are widely known that can generate codes in an entirely deterministic manner, yet which appear to be random. The sequences generated by such algorithms can be very difficult to reproduce by others if the algorithm is not divulged. Moreover, even if the particular pseudo-random algorithm used is made known, it can still be very difficult to predict its future output by inspection of its past output without knowledge of a “seed” value which is used as an parameter to the algorithm. Such a seed value can be securely exchanged between the server that generates a web page and a receiving mail server. In addition to a pseudo-random number, the date and time of creation or expiry of the authorisation code may be encoded within it, so that the server need not maintain a list of authorisation codes and the time at which their validity expires. For example, many systems maintain a time value represented by an count of seconds that have elapsed from a base date and time. An example is POSIX time, which is a count of seconds that has elapsed from 1 Jan. 1970. This can be algorithmically converted to an alphanumeric string using an encryption algorithm. The algorithm can be public, but makes use of an encryption key that is private. When the message is received, the encrypted time can be decoded from the e-mail address. This can be interpreted either as a time that the address was created or as a time at which the validity of the e-mail address expires.

Alternatively, an authorisation code may be generated in response to a request made by a prospective sender. In such cases, an authorisation code can be generated that is valid only for one specific sender, and may also be time limited. There are many ways in which the generated e-mail address with its code can be conveyed to the prospective sender.

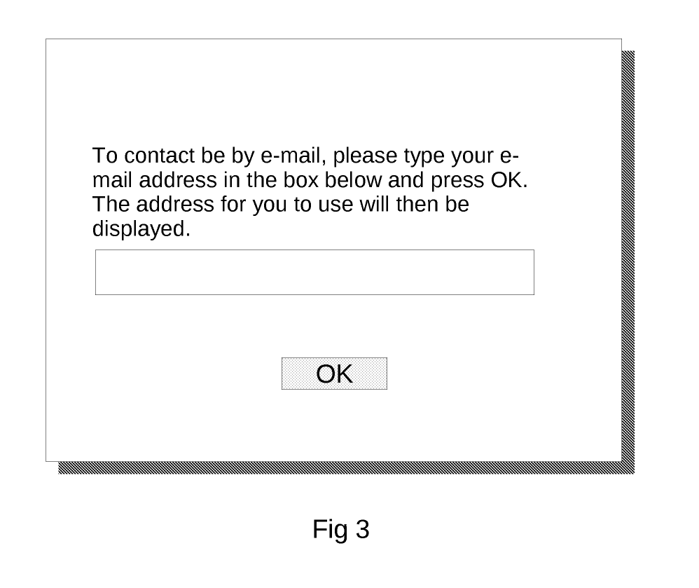

One mechanism for doing this is to ask the sender to enter their e-mail address into a form, such as shown in FIG. 3, and then to generate a subsequent page that includes the authorisation code encoded within an e-mail address (which may be broadly similar to that shown in FIG. 2). In this case, the authorisation code will typically be generated algorithmically much as described above. However, the authorisation code that is generated will either encode the prospective senders e-mail address for subsequent checking, or the authorisation code may be stored in a table along with the prospective senders e-mail address.

If the complete e-mail address, with the authorisation code, is used by the correct sender within its period of validity, the sender is optionally added to the receivers accept list, whereupon the authorisation code can be omitted from future messages.

When an authorisation code is to be conveyed to a user as part of a web page, page code (e.g., HTML code) must be generated that, when rendered by a prospective senders web browser, will display the authorisation code in a manner that can be read by the prospective sender. To achieve this, the page code includes code that constructs a request to be sent to the system server 10, including the identity of the sender and the receiver. This request is processed by the system server 10, which generates the authorisation code, sets up internal tables to allow validation of the code, and which returns HTML that can be included in a web page for rendering in a web browser. It will be noted that this can be performed by a web server that is entirely conventional—only the page code need have suitable instructions for incorporating the generated e-mail address.

At the option of the recipient, or the operator of the server, once an e-mail address and authorisation code combination has been used validly, it may then continue to remain valid indefinitely (although it cannot be used to authorise a new sender). This is useful where a user wishes to authorise contact from other websites, such as e-commerce sites that require a contact e-mail address, or automated e-mail systems such as mailing list daemons, that will continue to use an unaltered e-mail address. In such cases, the authorisation code may be revoked by the recipient at any time if the e-mail address and authorisation code combination has started to receive unwanted messages. Moreover, since a record is kept of the identity of the sender to whom the authorisation code has been issued, it is possible for the server can determine the identity of the person from whom the unwanted messages originated or from whom the sender of the unwanted messages obtained the e-mail address.

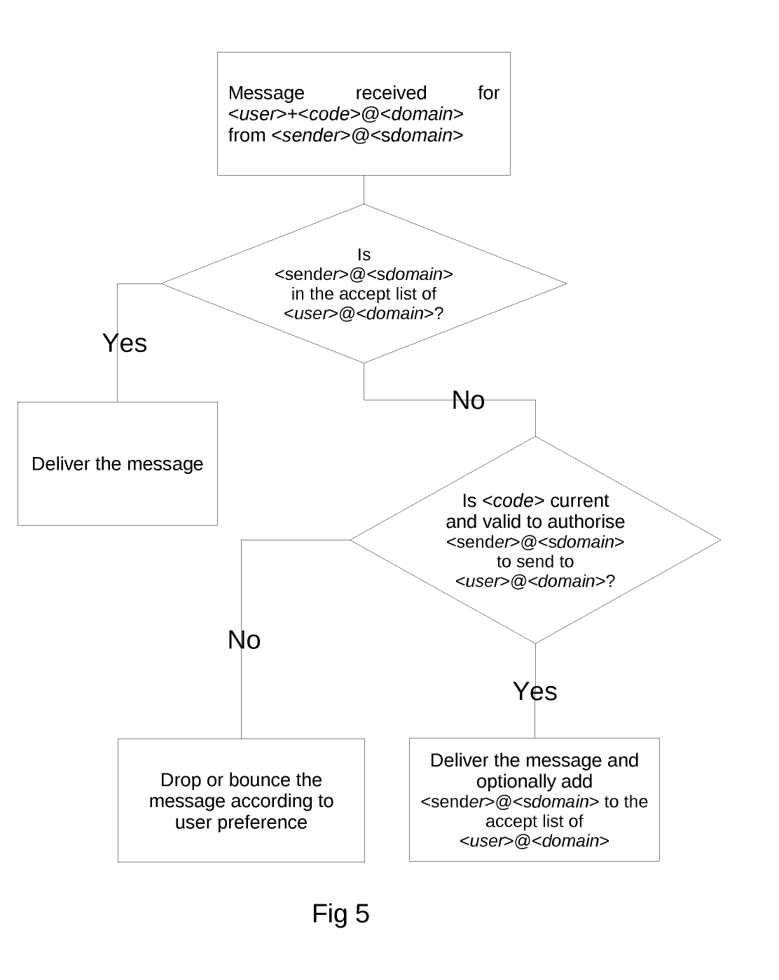

Alternatively, the authorisation code may be valid only once, and, once the sender is added to the accept list, subsequent messages must be sent to the recipients conventional e-mail address—that is, the e-mail address without the authorisation code (effectively removing the first decision box in FIG. 5). This allows the system to retain compatibility with RFC 5233.

1. A method of handling e-mail messages comprising:
a. receiving an e-mail message from a sender for delivery to a recipient, delivering the message if the sender is included in a list of senders authorised for communication with the recipient; or
b. parsing a destination e-mail address in the message to extract from it an authorisation code and if the authorisation code is an acceptable code, adding the sender to the list of senders authorised for communication with the recipient and delivering the message;
c. wherein any authorisation code has a validity that us is limited for a specific length of time.

2. A method of handling e-mail messages according to claim 1 in which the authorisation code is an alphanumeric code.

3. A method of handling e-mail messages according to claim 1 in which the authorisation code is an acceptable code if it is contained within a table of acceptable codes.

4. A method of handling e-mail messages according to claim 1 in which an algorithm can be applied to the authorisation code to determine whether it is an acceptable code.

5. A method of handling e-mail messages according to claim 4 in which one or both of the time of creation of the authorisation code and the time of expiry of validity of the authorisation code is encoded within the authorisation code.

6. A method of handling e-mail messages according to claim 5 in which the authorisation code includes an encrypted representation of a numerical time value.

7. A method of handling e-mail messages according to claim 1 in which the authorisation code has validity for a period of the order of several minutes or several hours.

8. (canceled)

9. A mail server operative to receive an e-mail message and handle it in accordance with a method of claim 1.

10. A computer software product that can be executed on a computing platform to provide a mail server according to claim 9.

11. A method of establishing e-mail communication comprising:
a. connecting a mail server according to claim 10 to a network to receive e-mail messages from a sender;
b. operating a web server connected to the network to serve page code for a web page that includes an e-mail address that comprises an authorisation code, wherein the page code for subsequent instances of the page that are served have different authorisation codes.

12. A method according to claim 11 in which the page code for the web page served includes an HTML mail to link that contains the e-mail address including the authorisation code.

13. A method according to claim 11 in which the page code indicates a date and/or time of expiry of validity of the authorisation code contained within the instance of the page.

14. A method according to claim 11 in which the network includes the Internet.
